(19) United States
(12) Patent Application Publication
(10) Pub. No.: US 2007/0081743 A1
(43) Pub. Date: Apr. 12, 2007

(54) Image interpolation apparatus and method thereof

(75) Inventor: Jea-won Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/393,703

(22) Filed: Mar. 31, 2006

(30) Foreign Application Priority Data
Oct. 8, 2005 (KR) 2005-0094664

(51) Int. Cl. G06K 9/32; H04N 7/01

(52) U.S. Cl. 382/299; 348/458

(57) ABSTRACT

An image interpolation apparatus includes: a frequency component detecting part detecting a frequency component in the unit of pixel data included in an input image signal; a coefficient storing part storing a plurality of interpolation coefficients corresponding to a plurality of frequency component sections; a coefficient controlling part selecting a certain interpolation coefficient corresponding to the frequency component detected in the unit of pixel data at the coefficient storing part; and an interpolation filtering part filtering the pixel data with the selected interpolation coefficient and outputting the interpolated pixel data. Accordingly, an interpolation adaptive to images in high and low frequency areas are performed to output enhanced picture quality.

### CROSS-REFERENCE TO RELATED APPLICATIONS

This application claims priority from Korean Patent Application No. 10-2005-0094664, filed Oct. 8, 2005, in the Korean Intellectual Property Office, the entire contents of which are incorporated herein by reference.

### BACKGROUND OF THE INVENTION

1. Field of the invention

Apparatuses and methods consistent with the present invention relate to image interpolation, and more particularly, to applying a proper interpolation coefficient according to a frequency of a received image signal, interpolating and printing the image signal, and converting the image signal received in various formats into the format corresponding to a display device.

2. Description of the Related Art

Recently, a variety of differently-sized image displaying devices, especially a large-size and high-quality image displaying device is in common use due to technological advancements. Accordingly, an image signal output from an image medium is required to be at high quality, and therefore, there is an increasing demand for an image format conversion technology to enlarge or reduce an image.

In particular, an image format conversion technology is needed to horizontally or vertically expand the image, in order to display a variety of image signals in different formats in a single display device. The image format conversion technology is referred to as an image interpolation method. Generally, when an image signal at a lower resolution than the preset is inputted, the image interpolation method is applied to the display device.

Conventional interpolation methods include a Cubic Convolution Interpolation or a Poly Phase Interpolation. Conventional arts using the Cubic Convolution Interpolation or the Poly Phase Interpolation will be mentioned later with reference to FIG. 1.

FIG. 1 shows a construction of a conventional image interpolation apparatus.

Referring to FIG. 1, the conventional image interpolation apparatus 10 includes a frequency judging part 12, a controlling part 14, a coefficient storing part 16 and a data processing part 18.

The frequency judging part 12 analyzes frequency or level of an input image signal, and outputs an interpolation coefficient selection signal. The interpolation coefficient selection signal selects an interpolation coefficient corresponding to one interpolation method out of the Cubic Convolution Interpolation or the Poly Phase Interpolation, with respect to the input image signal.

That is, the frequency judging part 12 outputs an interpolation coefficient selection signal corresponding to the Cubic Convolution Interpolation when the input image signal increases or decreases three consecutive times, and outputs an interpolation selection signal coefficient corresponding to the Poly Phase Interpolation when the input image signal has value differences at a certain level or lower.

The controlling part 14 controls the input and output speed of the image signal input into the data processing part 18 which will be described in detail below. According to the ratio of the image signal input into the data processing part 18, to the image signal output from the data processing part 18, phase information corresponding to the position to interpolate the input image signal is created and output.

The coefficient storing part 16 selects one interpolation method out of the Cubic Convolution Interpolation or the Poly Phase Interpolation, according to the interpolation coefficient selection signal output from the frequency judging part 12 and the phase information output from the controlling part 14. An interpolation coefficient corresponding the selected interpolation method is determined and output.

The data processing part 18 includes seven delayers, eight multipliers and one adder interpolating the input image signal according to the interpolation coefficient output from the coefficient storing part 16. When the interpolation coefficient which corresponds to the Cubic Convolution Interpolation selected from the coefficient storing part 16 is transmitted, the data processing part 18 applies four-tap filtering and performs interpolation. That is, four neighboring pixels on a position where the interpolation is performed are used to filter the input image signal.

When the interpolation coefficient which corresponds to the Poly Phase Interpolation selected from the coefficient storing part 16 is transmitted, the data processing part 18 applies eight-tap filtering and performs interpolation. That is, eight neighboring pixels on a position where the interpolation is performed are used to filter the input image signal.

As mentioned above, when the Cubic Convolution Interpolation is applied, the high frequency component deteriorates, and thereby generates a blur. When the Poly Phase Interpolation is applied, a blur-less clear image is obtained, but ringing is generated around the edge due to the loss of high frequency substances, because most image signals including the edge are band-limitless.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides an image interpolation apparatus and a method thereof outputting a blur-less or ringing-less image signal, by judging a frequency component of an input image signal and applying an interpolation coefficient corresponding to the frequency component differently according to an area of the input image, in order to achieve improved picture quality in an image interpolation.

According to an aspect of the present invention, there is provided an image interpolation apparatus comprising: a frequency component detecting part detecting a frequency component in the unit of pixel data included in an input image signal; a coefficient storing part storing a plurality of interpolation coefficients corresponding to a plurality of frequency component sections, respectively; a coefficient controlling part selecting a certain interpolation coefficient corresponding to the frequency component detected in the unit of pixel data at the coefficient storing part; and an interpolation filtering part filtering the pixel data with the selected interpolation coefficient and outputting the interpolated pixel data.

The frequency component detecting part calculates differences between respective adjacent pixel data included in the input image signal as many times as the number of filtering taps and obtains an average of the differences, to thereby detect the frequency component.

The coefficient controlling part selects a first interpolation coefficient corresponding to a first frequency component section, when the frequency component detected by a pixel data unit included in the input image signal is included in the first frequency component section of the frequency component sections stored in the coefficient storing part.

The interpolation filtering part may control the pixel data to be input and the interpolated pixel data to be output, according to an input and output ratio between the pixel data and the interpolated pixel data. The interpolation filtering part may further output phase information corresponding to a position where the pixel data is interpolated, according to the input and output ratio between the pixel data and the interpolated pixel data.

The coefficient controlling part transmits the interpolation coefficient to the interpolation filtering part to interpolate the pixel data according to the phase information.

According to an aspect of the present invention, there is provided an image interpolation method including: detecting a frequency component by unit of pixel data included in the input image signal; selecting an interpolation coefficient corresponding to the frequency component detected in the unit of pixel data; and filtering the pixel data with the selected interpolation coefficient and outputting an interpolated pixel data.

The image interpolation method may further comprise storing a plurality of interpolation coefficients corresponding to a plurality of frequency component sections.

The operation of detecting the frequency component calculates differences between respective adjacent pixel data included in the input image signals as many times as the number of filtering tap and obtains an average of the differences.

The operation of selecting the interpolation coefficient selects the first interpolation coefficient corresponding to the first frequency component section, when the frequency component detected in the unit of the pixel data included in the input image signal is included in the first frequency component section of the frequency component sections.

The outputting the interpolated pixel data further comprises: controlling the pixel data to be input and the interpolated pixel data to be output, according to an input and output ratio between the pixel data and the interpolated pixel data, and outputting phase information corresponding to the position where the pixel data is interpolated; and transferring the interpolation coefficient to interpolate the pixel data according to the phase information.

### BRIEF DESCRIPTION OF THE DRAWING FIGURES

The above and/or other aspects of the present invention will become more apparent by describing in detail exemplary embodiments thereof with reference to the attached drawing figures, wherein;

FIG. 1 shows a construction of a conventional image interpolation apparatus;

FIG. 2 shows a construction of an image interpolation apparatus according to an exemplary embodiment of the present invention;

FIGS. 3A and 3B show a pixel data input into the image interpolation apparatus according to an exemplary embodiment of the present invention; and

FIG. 4 is a flowchart for explaining an operation of the image interpolation apparatus according to an exemplary embodiment of the present invention.

### DETAILED DESCRIPTION OF THE EXEMPLARY EMBODIMENTS

Hereinafter, an exemplary embodiment of the present invention will be described in detail with reference to the accompanying drawing figures.

In the following description, same drawing reference numerals are used for the same elements even in different drawings. The matters defined herein are described at a high-level of abstraction to provide a comprehensive yet clear understanding of the invention. It is also to be noted that it will be apparent to those ordinarily skilled in the art that the present invention is not limited to the description of the exemplary embodiments provided herein.

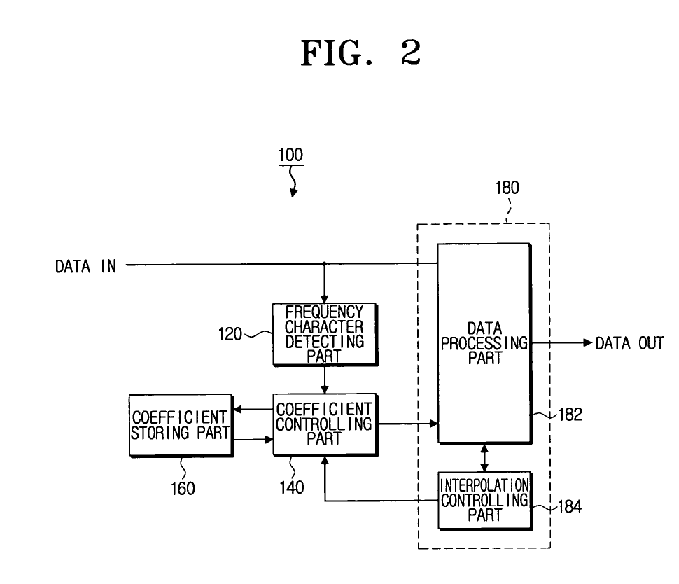

FIG. 2 shows a construction of an image interpolation apparatus according to an exemplary embodiment of the present invention.

Referring to FIG. 2, the image interpolation apparatus 100 includes a frequency component detecting part 120, a coefficient storing part 160, a coefficient controlling part 140 and an interpolation filtering part 180.

The frequency component detecting part 120 detects a frequency component by a unit of pixel data included in an input image signal. The input image signal is in a form of YCbCr.

More specifically, the frequency component detecting part 120 calculates and averages differences between adjacent pixel data included in the input image signals as many times as the number of filtering taps, to detect the frequency component by a unit of pixel data. The filtering tap refers to a multiplier included in an interpolation filtering part 180 described below.

The coefficient storing part 160 stores a plurality of interpolation coefficients corresponding to respective frequency component sections classified into a plurality of steps. The plurality of frequency component sections are preset as a threshold value obtainable from an experiment and stored.

For example, there are a first threshold value and a second threshold value existing, and when the first threshold value is bigger than the second threshold value, the frequency component section is classified into three sections. Interpolation coefficients corresponding to respective frequency component sections are a sharp filter coefficient, a smooth filter coefficient, and a moderate filter coefficient, and stored in the coefficient storing part 160.

The coefficient controlling part 140 selects the interpolation coefficient corresponding to the frequency component detected in a unit of pixel data from the coefficient storing part 160, and transfers the selected interpolation coefficient to the interpolation filtering part 180. For example, the coefficient controlling part 140 selects the sharp filter coefficient stored in the coefficient storing part 160, when the frequency component detected in a unit of pixel data included in the input image signal is bigger than the first threshold value.

Alternatively, when the detected frequency component is smaller than the second threshold value, the coefficient controlling part 140 selects the smooth filter coefficient from the coefficient storing part 160. When the detected frequency component is smaller than the first threshold value and bigger than the second threshold value, the coefficient controlling part 140 selects the moderate filter coefficient from the coefficient storing part 160.

The coefficient controlling part 140 receives more information regarding phase output from the interpolation filtering part 180, and provides the interpolation coefficient selected according to the information on the phase to the interpolation filtering part 180.

The interpolation filtering part 180 filters the input pixel data with the interpolation coefficient provided from the coefficient controlling part 140, and outputs the interpolated pixel data. The interpolation filtering part 180 includes a data processing part 182 and an interpolation controlling part 184.

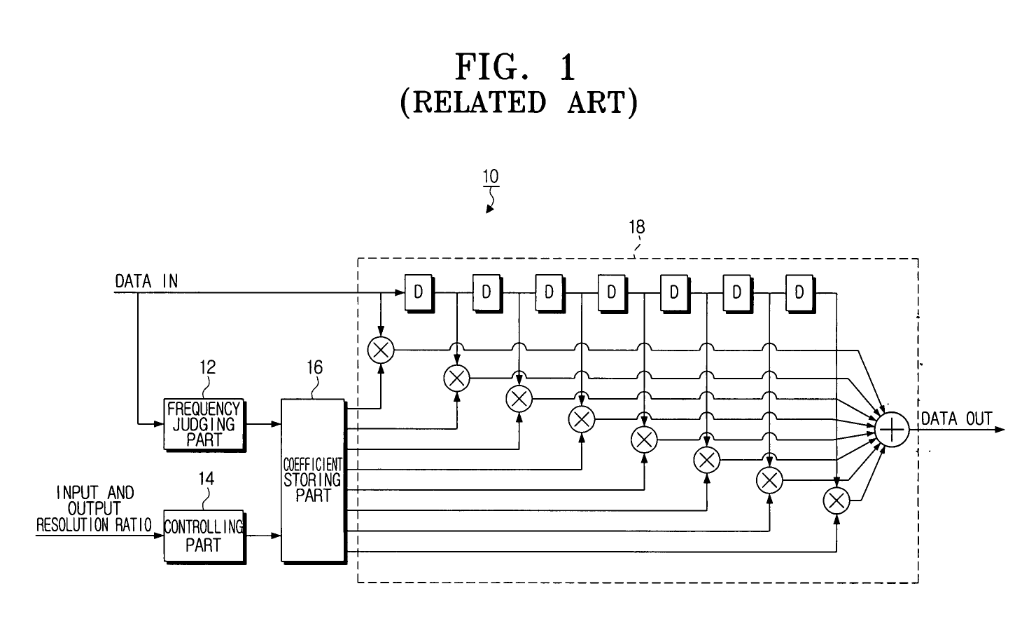

The data processing part 182 includes a delayer (not shown), a multiplier (not shown) and an adder (not shown). The data processing part 182 has the same structure as the data processing part 18 of FIG. 1, but the number of delayers and multipliers may be more than one, depending on design conditions. That is, according to an exemplary embodiment of the present invention, in a vertical interpolation the data processing part 182 has the same structure as the data processing part 18 of FIG. 1, while the data processing part 182 has 11 delayers and 12 multipliers in a horizontal interpolation.

The delayer delays the input pixel data for a predetermined time and outputs to the multiplier, and the multiplier multiplies the interpolation coefficient provided from the coefficient controlling part 140 by the pixel data. For example, in the horizontal interpolation, the number of interpolation coefficients multiplied by the pixel data (D0˜D11) may be 12, and each of the interpolation coefficients may be ‘0’ or have a predetermined value. The pixel data multiplied by 12 interpolation coefficients are added with the adder to output the interpolated pixel data.

When enlarging the input image signal, the interpolation controlling part 184 controls input velocity of the pixel data input into the data processing part 182, according to the resolution ratio between the input and output. When reducing the input image signal, the interpolation controlling part 184 controls output velocity of the interpolated pixel data output from the data processing part 182 according to the resolution ratio between the input and output. The interpolation controlling part 184 provides the phase information corresponding to a position to interpolate the pixel data to the coefficient controlling part 140.

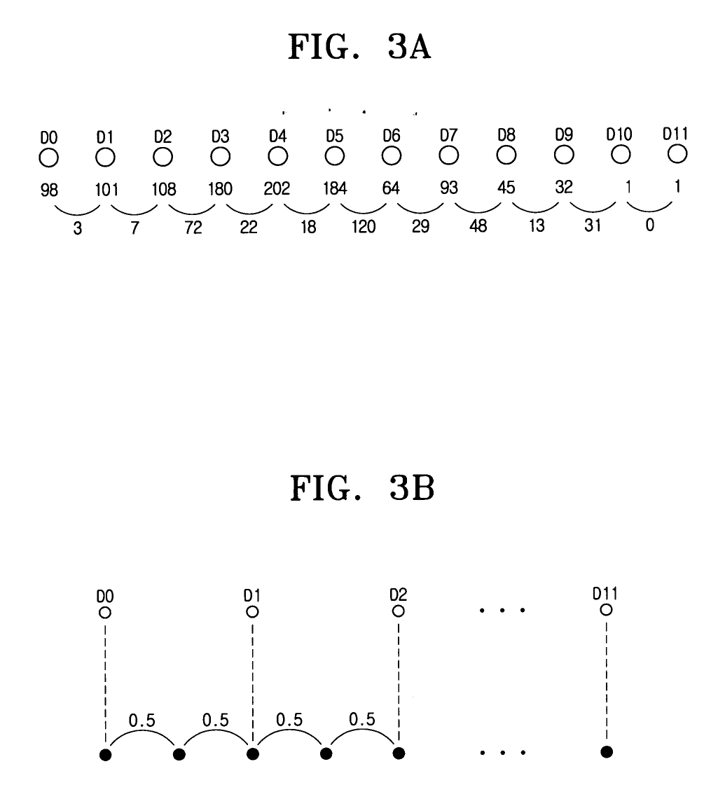

FIGS. 3A and 3B show a pixel data input into the image interpolation apparatus according to an exemplary embodiment of the present invention.

Referring FIG. 3A, the frequency component detecting part 120 calculates and averages the differences between adjacent data with respect to 12 respective input pixel data, to detect the frequency component in a unit of pixel data. The detected frequency component value is 33. The coefficient controlling part 140 judges where the frequency component value is included from the frequency component sections stored in the coefficient storing part 160, and reads the interpolation coefficient corresponding to the judged frequency component section, from the coefficient storing part 160.

The interpolation coefficient is provided to the data processing part 182 according to the phase information provided from the interpolation controlling part 184. FIG. 3B shows input and output resolution ratio at 1:2, and a scale factor is 0.5 that decides a position to interpolate the pixel data according to the phase information.

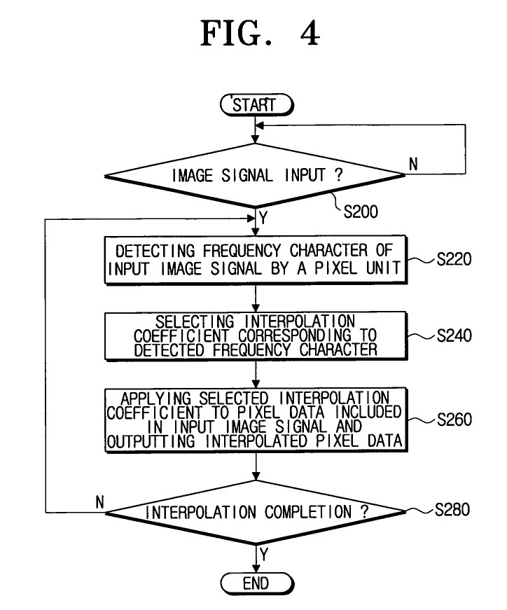

FIG. 4 is a flowchart for explaining an operation of the image interpolation apparatus according to an exemplary embodiment of the present invention.

If it is judged that the image signal is input into the image interpolation apparatus (S200), the frequency component of the input image signal is detected in a unit of pixel data. That is, the frequency component detecting part 120 calculates and averages differences between the input pixel data, to detect the frequency component of the input image signal in a unit of pixel data. The frequency component detecting part 120 calculates and averages differences between the adjacent pixel data as many as the number of multipliers included in the data processing part 182 with respect to the pixel data included in the input image signal, to detect the frequency component in a unit of pixel data (S220).

The interpolation coefficient corresponding to the detected frequency component is selected. That is, the coefficient controlling part 140 judges where the frequency component detected by the frequency component detecting part 120 is included from the frequency component sections. The coefficient controlling part 140 selects the interpolation coefficient corresponding to the judged frequency component section and provides the selected interpolation coefficient to the data processing part 182. The coefficient controlling part 140 provides the interpolation coefficient to the data processing part 182 for the pixel data to be interpolated according to the phase information output from the interpolation controlling part 184 (S240).

The selected interpolation coefficient is applied to the pixel data included in the input image signal. More specifically, the data processing part 182 multiplies and adds the interpolation coefficient provided by the coefficient controlling part 140 to the pixel data included in the input image signal to output the interpolated pixel data (S260).

If it is judged that the interpolation is completed for one frame or one field, operation of the image interpolation apparatus 100 ends, and if it is judged that the interpolation is not completed, operations S220 through 260 are repeated (S280).

In this process, the interpolation is performed according to the frequency component of the pixel unit of the input image signal.

As mentioned above, according to an exemplary embodiment of the present invention, the frequency component of the input image signal is judged by a unit of pixel data, and the interpolation coefficient corresponding to the judged frequency component is applied to the input pixel data, so that blur or ringing is removed and an image in an high frequency area is output at high picture quality, while an image in an low frequency area is output at a softer picture.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image interpolation apparatus comprising:
a frequency component detecting part which detects a frequency component in a unit of pixel data included in an input image signal;
a coefficient storing part which stores a plurality of interpolation coefficients corresponding to a plurality of frequency component sections;
a coefficient controlling part which selects an interpolation coefficient corresponding to the frequency component detected in the unit of pixel data from the coefficient storing part; and
an interpolation filtering part which filters the pixel data with the selected interpolation coefficient and outputs interpolated pixel data.

2. The image interpolation apparatus of claim 1, wherein the frequency component detecting part calculates differences between respective adjacent pixel data included in the input image signal as many times as a number of filtering taps, and obtains an average of the differences to detect the frequency component.

3. The image interpolation apparatus of claim 1, wherein the coefficient controlling part selects a first interpolation coefficient which corresponds to a first frequency component section, if the frequency component is in the first frequency component section of the frequency component section.

4. The image interpolation apparatus of claim 1, wherein the interpolation filtering part controls the pixel data to be input and the interpolated pixel data to be output, according to an input and output ratio between the pixel data and the interpolated pixel data.

5. The image interpolation apparatus of claim 1, wherein the interpolation filtering part further outputs phase information which corresponds to a position where the pixel data is to be interpolated, according to the input and output ratio between the pixel data and the interpolated pixel data.

6. The image interpolation apparatus of claim 5, wherein the coefficient controlling part transmits the interpolation coefficient to the interpolation filtering part to interpolate the pixel data according to the phase information.

7. The image interpolation apparatus of claim 1, wherein the interpolation filtering part comprises:
a data processing part which filters the pixel data with the selected interpolation coefficient and outputs the interpolated pixel data; and
an interpolation controlling part which controls the pixel data to be input and the interpolated pixel data to be output according to an input and output ratio between the pixel data and the interpolated pixel data, and outputs phase information corresponding to a position where the pixel data is interpolated.

8. The image interpolation apparatus of claim 7, wherein the coefficient controlling part transfers the interpolation coefficient to the interpolation filtering part to interpolate the pixel data according to the phase information.

9. An image interpolation method comprising:
detecting a frequency component in a unit of pixel data included in an input image signal;
selecting an interpolation coefficient corresponding to the frequency component detected by the unit of pixel data; and
filtering the pixel data with the selected interpolation coefficient and outputting interpolated pixel data.

10. The image interpolation method of claim 9, further comprising storing a plurality of interpolation coefficients corresponding to a plurality of frequency component sections.

11. The image interpolation method of claim 9, wherein the detecting the frequency component calculates differences between respective adjacent pixel data included in the input image signals as many times as the number of filtering tap and obtains an average of the differences.

12. The image interpolation method of claim 9, wherein the selecting the interpolation coefficient selects a first interpolation coefficient corresponding to a first frequency component section, if the frequency component is included in the first frequency component section of the frequency component section.

13. The image interpolation method of claim 9, wherein the outputting the interpolated pixel data comprises:
controlling the pixel data to be input and the interpolated pixel data to be output, according to an input and output ratio between the pixel data and the interpolated pixel data; and
outputting phase information corresponding to the position where the pixel data is interpolated.

14. The image interpolation method of claim 9, wherein the outputting the interpolated pixel data comprises transferring the interpolation coefficient to interpolate the pixel data according to the phase information.
